(19) United States
(12) Patent Application Publication
(10) Pub. No.: US 2008/0019764 A1
(43) Pub. Date: Jan. 24, 2008

(54) Spring post fastening system and method

(76) Inventors: Glenn Jakins, Provo, UT (US); Gregory Brooks, Pokfulam (HK)

Correspondence Address: RADER, FISHMAN & GRAUER PLLC, 10653 SOUTH RIVER FRONT PARKWAY, SUITE 150, SOUTH JORDAN, UT, 84095, US

(21) Appl. No.: 11/801,833

(22) Filed: May 11, 2007

Related U.S. Application Data
(60) Provisional application No. 60/799,778, filed on May 11, 2006.

(51) Int. Cl. B42F 3/02

(52) U.S. Cl. 402/21

(57) ABSTRACT

A spring post fastening system includes a reception member including a bottom interference member and a center protrusion extending from the bottom interference member, the center protrusion defining a center reception orifice and a retention notch, and an engagement member~including a top interference member and an engagement protrusion coupled to the top interference member. The engagement protrusion includes at least one notch engagement protrusion. Further, the engagement protrusion is configured to slideably engage the reception orifice.

### RELATED APPLICATIONS

This application claims the benefit under 35 U.S.C. § 119(e) of U.S. Provisional Patent Application No. 60/799,778 filed May 11, 2006 titled “Spring Post Fastening System and Method,” which provisional application is incorporated herein by reference in its entirety.

### BACKGROUND

The first known Latin manuscript, circa 55 A.D. was protected by two wooden covers bound on one side by leather thongs to act as a hinge. Today, there are many different types of binding systems. One type of hardback binding is adhesive binding using glue with an integral cover to permanently secure the pages within the cover. While adhesive bindings are used for permanently binding the pages of books, there are many other types of less permanent and less expensive binding systems which serve the basic needs of protecting, storing and providing convenient access to the bound information.

Perhaps the best known non-permanent binding system is the three ring binder. The three ring binder is available in a variety of different sizes ranging from one inch to five inches for holding various numbers of pages therein. The rings may be round, D-shaped or elliptical rings and are opened and closed for adding, removing and rearranging pages. One disadvantage of a three ring binder is that the size of each binder is fixed and it is not reducible or expandable to accommodate varying number of pages therein. Thus, the user may select a binder which is too large or too small for the number of pages to be held by the rings of the binder. If the number of pages placed in the rings exceeds the capacity of the rings, the rings may not close properly and the pages may be difficult to turn or may become loose. Furthermore, if the number of pages retained by the rings is less than the capacity of the rings, then the user may be left with a bulky binding system having exposed rings. In either case, the number of pages may increase or decrease as the user adds or removes pages and it may be difficult to select a binder which is sized to match the number of pages held in the binder at any given time. Another disadvantage is that the three ring binder does not typically lay flat in its closed condition and thus may be difficult to store and may be less aesthetically pleasing in both the opened and closed conditions.

Other types of non-permanent binding systems include wire bindings, spiral coil bindings, comb bindings, and screw post bindings. Wire bindings and spiral coil bindings require special machinery to punch holes in sheets to be bound and insert the binding through the holes. While these types of bindings are not permanent and are often used to bind reports and presentations, one disadvantage is that pages cannot be easily removed, rearranged, or added once they are secured because the binding must be removed and reattached using special machinery. In addition, the size of the wire or spiral coil is fixed so that the number of pages cannot exceed a certain predetermined amount.

Comb binding uses a separate spine to hold together punched pages and allows pages to be added, removed or rearranged. While comb bindings provide an expandable, lay flat binding system, one disadvantage is that bindings may be too bulky if only a small number of pages are to be bound.

Similarly, screw post binding uses two cover pieces and a removable spine to releasably hold punched pages together. FIGS. 1a through 1c illustrate a traditional screw post binding configuration, according to the prior art. As shown in FIGS. 1a through 1c, a traditional screw post binding system (100) includes a top (110) and a bottom (130) cover piece and a center spine member (120). A threaded male portion (115) is coupled to the top cover piece (110) and is configured to be threadably received in an internal threaded cavity (125) of the center spine member (120). As illustrated in FIG. 1c, the traditional screw post binding system (100) is then passed through a consistently placed hole in any number of album sheets or pages (160), binding them to an outer protective cover (150).

While the traditional screw post binding system (100) is often used to couple album sheets (160) to outer protective covers (150), the traditional screw post binding system suffers from a number of disadvantages. Particularly, the traditional screw post binding system is not expandable should an album need more pages than are easily accommodated by the size of the center spine member (120). Additionally, the required disassembly and reassembly of the parts each time a page is removed or added makes these types of bindings relatively complicated and not user-friendly. Particularly, the top cover piece (110) typically includes a reception depression configured to receive a flat or Phillips screwdriver. However, the reception depressions are typically flat and easily stripped, rendering the screw post unusable. Additionally, if too many pages are bound with the traditional screw post binding (100), insufficient threads may engage the internal threaded cavity, often resulting in stripping of the threads.

With the increasing popularity of showcasing photos and memorabilia in attractive keepsake albums and scrapbooks, the need for lay flat, attractive albums including user-friendly binding systems which allow pages to be removed, rearranged or added with ease has increased.

### SUMMARY

In one of many possible embodiments, the present exemplary system includes a spring post fastening system that securely couples a number of album sheets or pages while providing for the assembly or dis-assembly of the fastening system with less than a single rotation of the top member

Another embodiment of the present exemplary system provides an expansion member configured to allow for the selective expansion of the spring post fastening system.

Further, another embodiment of a spring post fastening system includes a reception member including a bottom interference member and a center protrusion extending from the bottom interference member, the center protrusion defining a center reception orifice and a retention notch, and an engagement member including a top interference member and an engagement protrusion coupled to the top interference member. The engagement protrusion includes at least one notch engagement protrusion. Further, the engagement protrusion is configured to slideably engage the reception orifice.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIGS. 1a through 1c are an assembled perspective view, an exploded view, and a perspective assembled view, respectively, of a traditional screw post binding system, according to the prior art.

FIG. 2 is a perspective assembled view of a spring post fastening system, according to one exemplary embodiment.

FIG. 3 is an exploded view of a spring post fastening system, according to one exemplary embodiment.

FIGS. 4a and 4b are perspective views of a top engagement member of the spring post fastening system of FIG. 2, according to various exemplary embodiments.

FIGS. 5a and 5b are perspective views of a bottom reception member of the spring post fastening system of FIG. 2, according to various exemplary embodiments.

FIGS. 6a and 6b are various side views of a spring system that may be incorporated into the spring post fastening system of FIG. 2, according to various exemplary embodiments.

FIGS. 7a through 7c illustrate an assembled view, an exploded view, and a system assembled view of a spring post expansion member, respectively, according to various exemplary embodiments.

Throughout the drawings, identical reference numbers designate similar, but not necessarily identical, elements.

### DETAILED DESCRIPTION

The present specification describes a spring post fastening system and method that may be used in connection with any number of document binding systems. While the present exemplary system may be used to bind any number of documents, and may be applied to any number of document binding systems, for ease of explanation only, the present exemplary system and method will be described in the context of a scrap book or picture album binding system. According to the present exemplary system and method, the spring post fastening system provides an efficient way to bind any number of pages in a flat configuration, while providing for a quick and easy disassembly of the coupling system to facilitate removal of desired pages. Further, the present specification describes an exemplary expansion member configured to allow for the spring post fastening system to have increased page handling capabilities with minor assembly.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

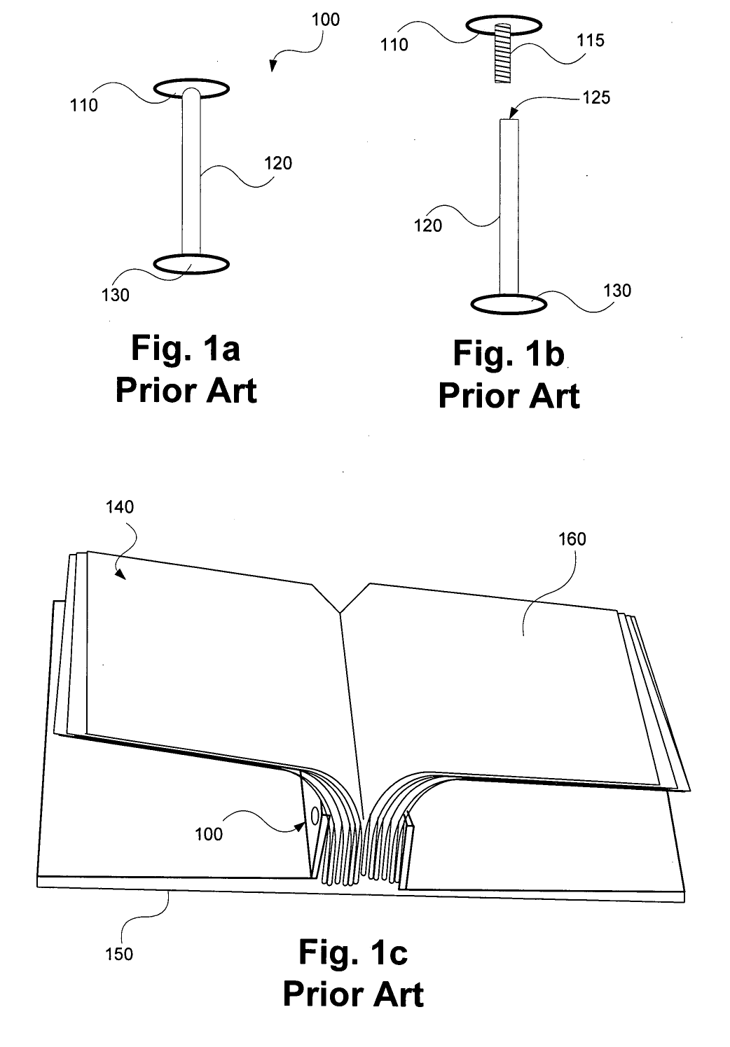

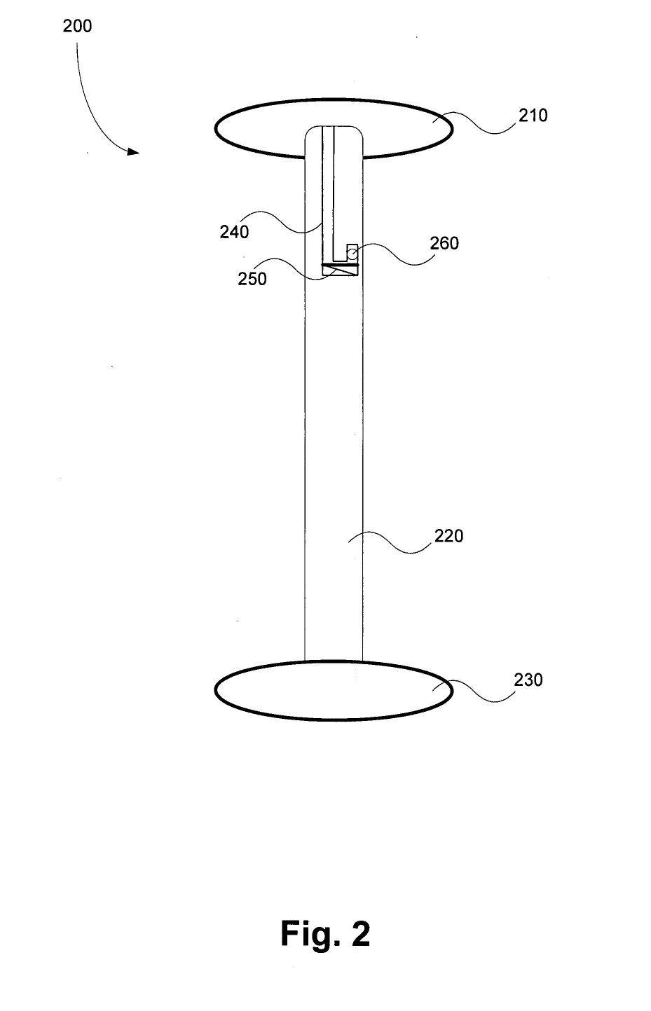

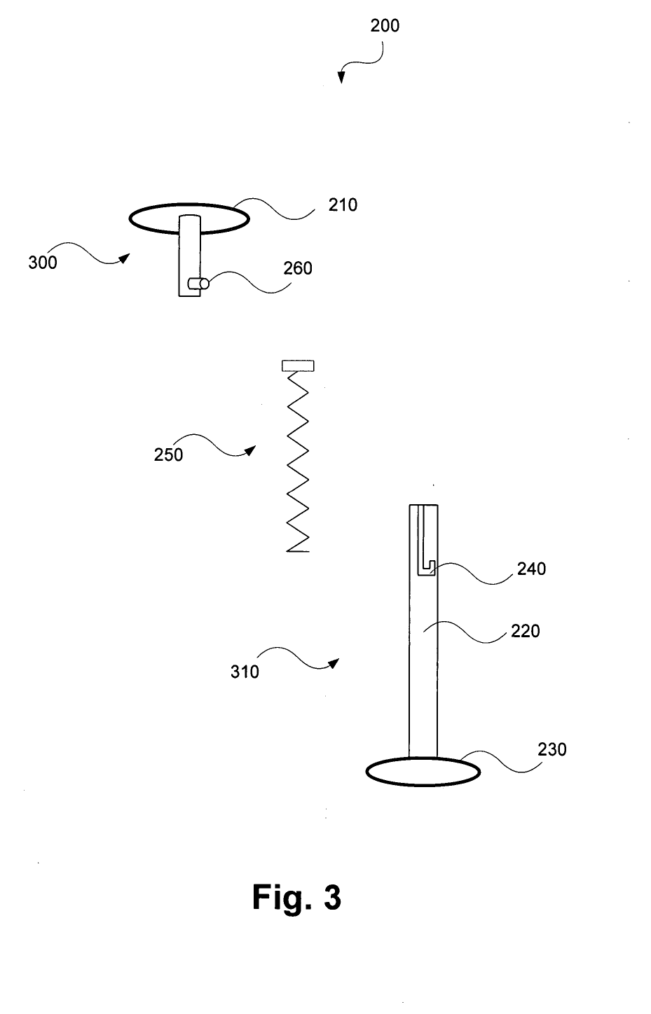

As mentioned, FIGS. 2 and 3 are respectively a perspective assembled view and an exploded view of a spring post fastening system (200), according to one exemplary embodiment. As shown in FIGS. 2 and 3, the present exemplary spring post fastening system includes a top (210) and bottom (230) cover piece including a center spine member (220), similar to the traditional screw post binding system (100; FIG. 1). However, the engagement member of the illustrated spring post fastening system (200) differs from the traditional threaded engagement system, thereby providing an easily opening system with simple expansion capabilities.

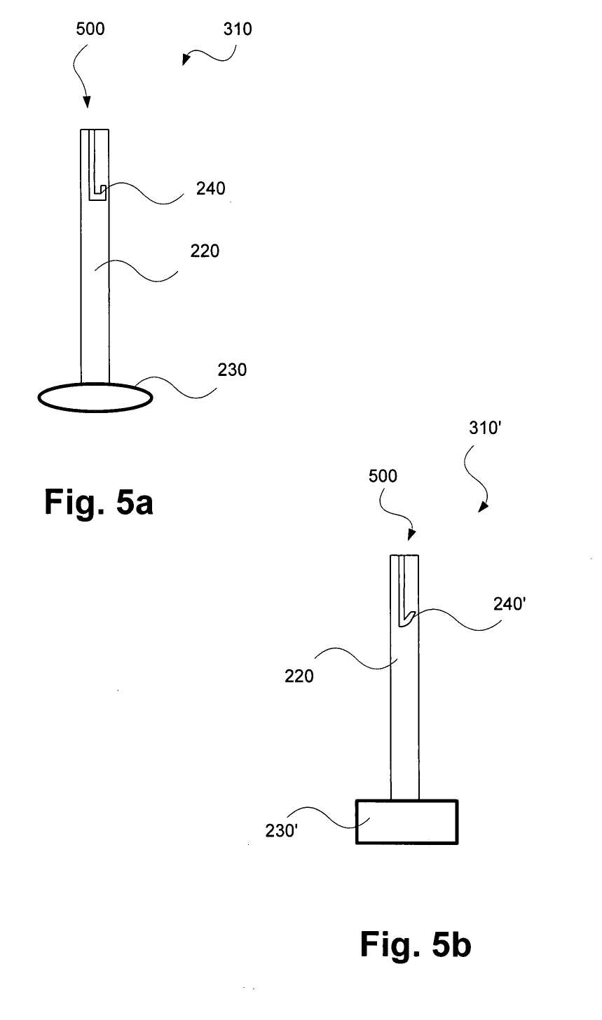

As shown in FIGS. 2 and 3, the top cover piece (210) forms a part of a top engagement member (300) including an engagement post (260) or protrusion. Additionally, the center spine member (220) and the bottom cover piece (230) are coupled together to form a bottom reception member (310). A “J” shaped retention notch (240) is formed in the side wall of the center spine member (220) in order to provide an engageable coupling interface with the top engagement member. While the retention notch (240) is illustrated in FIGS. 2 and 3 as a “J” shaped retention notch, any retention notch may be implemented by the present exemplary spring post fastening system (200) including, but in no way limited to and “L” shaped retention notch, or a “V” shaped retention notch as illustrated in FIG. 5B.

During assembly, when all the desired pages have been inserted over the center spine member (220), the top engagement member (300) may be inserted in a concentric orifice of the center spine member (220) with the engagement post (260) engaging and traversing the retention notch (240). Once completely inserted in the retention notch (240), the top engagement member (300) may then be rotated or otherwise translated into a locking position within the retention notch (240).

Additionally, as illustrated in FIGS. 2 and 3, a biasing member (210) may be inserted in an orifice concentrically disposed within the center spine member (220). According to one exemplary embodiment, the inclusion of the biasing member (250) within the center spine member (220) provides a resistive force to the insertion of the top engagement member (300) into the retention notch (240). Consequently, when the top engagement member (300) is at least partially rotated into a locking position, the biasing member may act to lift the top engagement member, when allowed by the shape of the retention notch (240), thereby causing the engagement post (260) to engage any locking features of the retention notch.

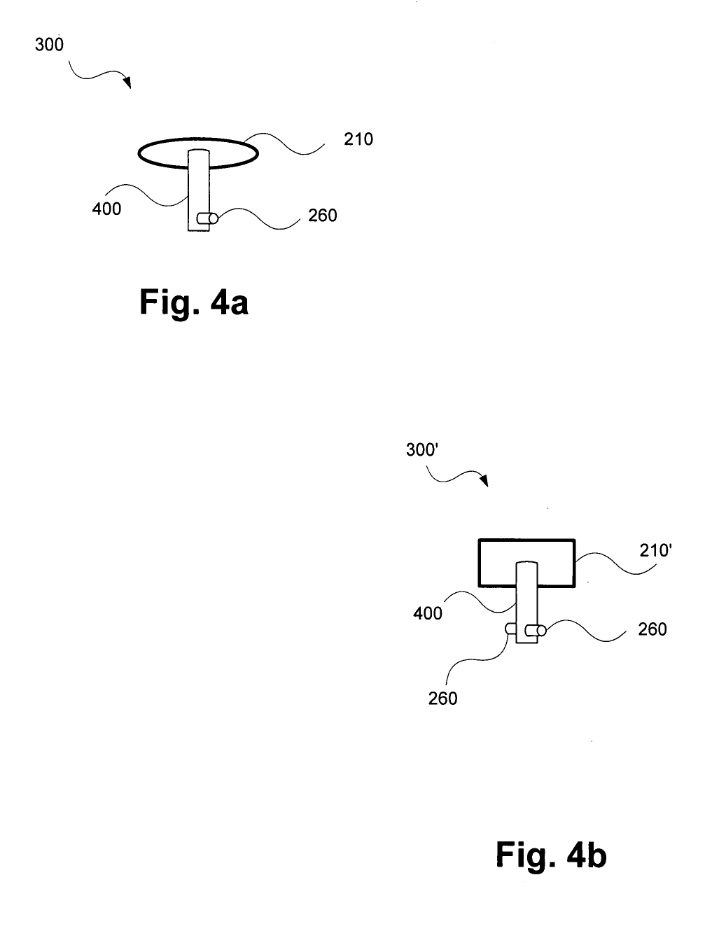

The present exemplary configuration allows for the easy insertion and locking of the spring post fastening system, without the shortcomings of the traditional screw post binding system (100; FIG. 1a). Particularly, engagement of the present exemplary spring post fastening system may be accomplished with less than a complete rotation of the top engagement member (300). Additionally, the rotation needed to lock the present spring post fastening system (200) may be input by a user's hand, without the use of tools. Further, due to the exemplary shape of the retention notch, engagement of the top engagement member (300) is either complete or not at all. Consequently, there is little or no risk of unintentional disconnection of the system, which may result in loss or damage of pages. Details of various components of the exemplary spring post fastening system (200) will be provided below with reference to FIGS. 4a through 7c.

FIGS. 4a and 4b are perspective views of a top engagement member (300) of the spring post fastening system (200) of FIG. 2, according to various exemplary embodiments. As illustrated in FIGS. 4a and 4b, the exemplary top engagement members (300, 300′) include a top cover piece (210, 210′) having a substantially planar surface that is larger than an orifice on a page being retained. As illustrated in the various figures, the top cover piece (210) may assume any number of geometries including, but in no way limited to, a circular, elliptical, square, quadrilateral, triangular, “X”, “T”, or other similar shape.

Regardless of the shape of the top cover piece (210, 210′), the top engagement member (300, 300′) includes a substantially smooth male protrusion (400) extending therefrom. According to the present exemplary spring post fastening system (200), the smooth male protrusion (400) is configured to be received in a center orifice defined in the center spine member (220). This mating feature allows for the insertion of the engagement post (260) into the retention notch (240). As demonstrated by FIGS. 4a and 4b, any number of retention notches (240), having any number of varying cross-sectional profiles may be formed on the smooth male protrusion (400), provided that there are at least as many corresponding retention notches (240) in the center spine member (220). Furthermore, the present exemplary top engagement member (300, 300′) may be manufactured from any number of materials including, but in no way limited to, metal, plastic, composites, or combinations thereof.

FIGS. 5a and 5b illustrate various views of a bottom reception member (310, 310′) of the spring post fastening system of FIG. 2, according to various exemplary embodiments. As illustrated in FIGS. 5a and 5b, the bottom reception member (310, 310′) may include a bottom cover piece (230) including a center spine member (220), similar to the traditional screw post binding system (100; FIG. 1). As shown, the bottom cover piece (230) may assume any number of geometric shapes. Also, as mentioned previously, a substantially circular concentric orifice (500) may be defined in the center spine member (220). According to one exemplary embodiment, the circular concentric orifice (500) is sized to receive the smooth male protrusion (400), facilitating engagement of the top cover piece (210).

FIGS. 5a and 5b also illustrate various embodiments of the retention notch (240, 240′), according to various exemplary embodiments. As shown, the exemplary retention notch may be defined by any profile configured to receive the engagement post or protrusion (260) and either allow for release of the engagement post or retention of the engagement post, depending on the rotational angle of the top engagement member (300, 300′).

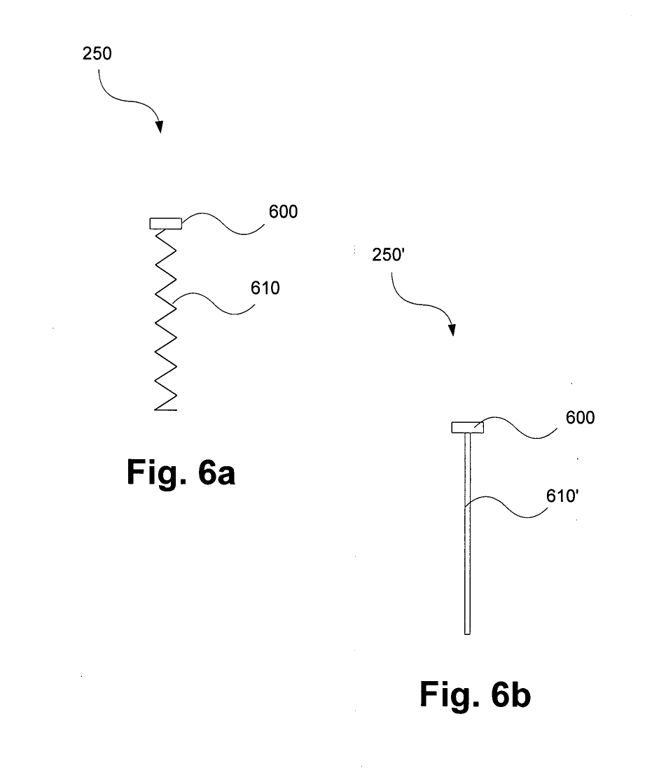

FIGS. 6a and 6b are various side views of exemplary spring systems that may be incorporated into the spring post fastening system of FIG. 2, according to various exemplary embodiments. As shown, the biasing member (250) may include a spring (610) and an engagement member (600). According to one exemplary embodiment, the spring (610) provides the resistive bias to the smooth male portion (400) during insertion, while the engagement member provides an even contact surface for the engagement. Additionally, during release, when the top cover piece (210, 210′) is rotated out of the retention notch (240, 240′), the spring provides an exiting force configured to push the top cover piece (210, 210′) out of the bottom reception member (310, 310′). As shown, the spring member (610) may be replaced by a compliant solid member (610′) providing a resistive bias to the insertion of the top cover piece (210). Additionally, according to one exemplary embodiment, the engagement member (600) may be removed and the spring (610) or compliant solid member (610′) may engage and impart a force directly on the substantially smooth male protrusion (400).

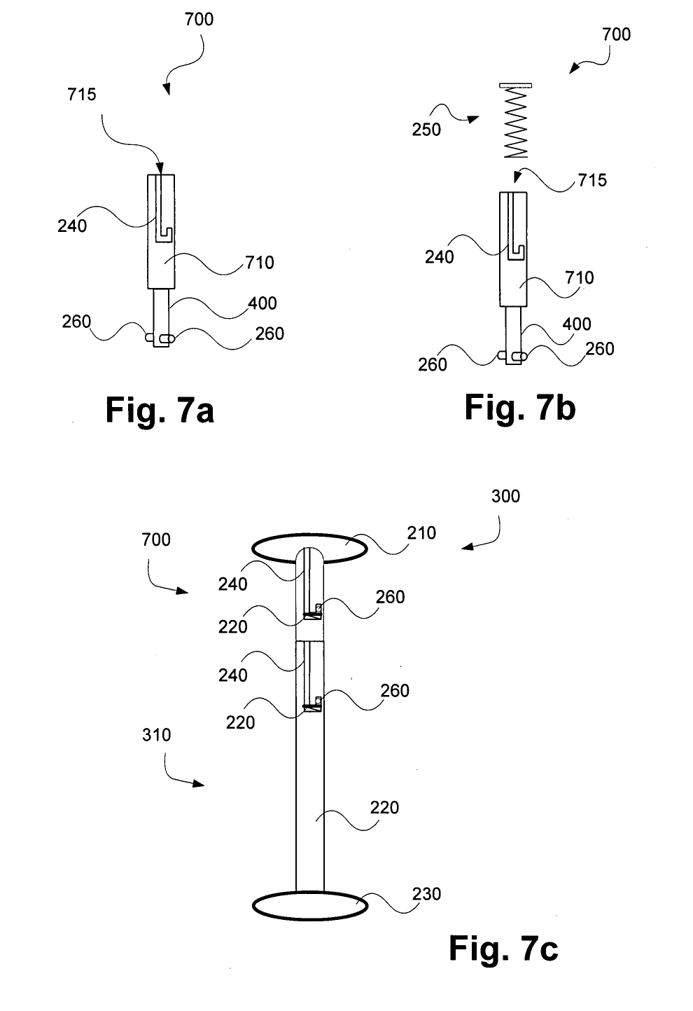

FIGS. 7a through 7c illustrate an assembled view, an exploded view, and a system assembled view of a spring post expansion member (700), according to various exemplary embodiments. As shown, an expansion member (700) configured to increase the page holding capability of the exemplary spring post fastening system (200) may include an expansion body (710) having a retention notch (240) and a center orifice (715) formed therein. Further, a substantially smooth male protrusion (400) including one or more engagement posts (260) extends from the bottom of the expansion body (710). As illustrated in FIG. 7c, the use of the expansion member (700) allows for the selective expansion of the spring post fastening system (200), increasing its page retention content. Specifically, the exemplary spring post expansion member (700) may include the external components of the top cover piece (210, 210′), plus a center orifice configured to receive a top cover piece. According to one exemplary embodiment, any number of expansion members may be consecutively coupled to allow the spring post fastening system (200) to retain any desired number of pages.

According to the present exemplary system and method, the spring post fastening system (200) may be manufactured out of any number of materials including, but in no way limited to, metals such as steel, aluminum, alloys, and the like; polymers such as structural plastics; composites; and combinations thereof.

The preceding description has been presented only to illustrate and describe embodiments of the invention. It is not intended to be exhaustive or to limit the invention to any precise form disclosed. Many modifications and variations are possible in light of the above teaching.

What is claimed is:

1. A page retention system, comprising:
a reception member including a bottom interference member and a center protrusion extending from said bottom interference member, said center protrusion defining a center reception orifice and a retention notch defined in a side wall of said center protrusion; and
an engagement member including a top interference member and an engagement protrusion extending from said top interference member, said engagement protrusion including at least one notch engagement protrusion extending tangentially from said engagement protrusion, said engagement protrusion being configured to slideably engage said reception orifice.

2. The system of claim 1, further comprising a biasing member disposed in said center reception orifice.

3. The system of claim 2, wherein said biasing member further comprises an engagement member disposed on said biasing member.

4. The system of claim 1, wherein said retention notch comprises one of a “J” shape, an “L” shape, or a “V” shape.

5. The system of claim 1, wherein said engagement protrusion is configured to be locked into said retention notch defined by said reception member by less than a 360 degree rotation of said engagement member.

6. An extendable spring post extension member comprising:
a reception member including a bottom interference member and a center protrusion extending from said bottom interference member, said center protrusion defining a center reception orifice and at least one retention notch defined in a side wall of said center protrusion;
an engagement member including a top interference member and an engagement protrusion extending from said top interference member, said engagement protrusion including at least one notch engagement protrusion extending tangentially from said engagement protrusion,;
an expansion body defining an extension retention notch and an extension center orifice, said extension center orifice being configured to slideably receive said engagement protrusion;
a substantially smooth male protrusion extending from said expansion body, wherein said substantially smooth male protrusion includes one or more extension engagement protrusions; and
wherein said substantially smooth male protrusion is configured to slideably engage said reception orifice.

7. The extendable spring post extension member of claim 6, further comprising a biasing member disposed in said center reception orifice.

8. The extendable spring post extension member of claim 7, wherein said biasing member further comprises an engagement member disposed on said biasing member.

9. The extendable spring post extension member of claim 7, further comprising a biasing member disposed in said extension center orifice.

10. The extendable spring post extension member of claim 6, wherein said retention notch comprises one of a “J” shape, an “L” shape, or a “V” shape.

11. The extendable spring post extension member of claim 6, wherein said extension retention notch comprises one of a “J” shape, an “L” shape, or a “V” shape.

12. The extendable spring post extension member of claim system of claim 6, wherein:
said engagement protrusion is configured to be locked into said extension retention notch by less than a 360 degree rotation of said expansion body; and
said extension engagement protrusion is configured to be locked into said retention notch by less than a 360 degree rotation of said engagement member.

13. An extendable spring post extension member comprising:
a reception member including a bottom interference member and a center protrusion extending from said bottom interference member, said center protrusion defining a center reception orifice and at least one retention notch defined in a side wall of said center protrusion, further including a first biasing member disposed in said center reception orifice;
an engagement member including a top interference member and an engagement protrusion extending from said top interference member, said engagement protrusion including at least one notch engagement protrusion extending tangentially from said engagement protrusion,;
an expansion body defining an extension retention notch and an extension center orifice, said extension center orifice being configured to slideably receive said engagement protrusion, including a second biasing member disposed in said extension center orifice;
a substantially smooth male protrusion extending from said expansion body, wherein said substantially smooth male protrusion includes one or more extension engagement protrusions;
wherein said substantially smooth male protrusion is configured to slideably engage said reception orifice;
said engagement protrusion is configured to be locked into said extension retention notch by less than a 360 degree rotation of said expansion body; and
said extension engagement protrusion is configured to be locked into said retention notch by less than a 360 degree rotation of said engagement member.

14. The extendable spring post extension member of claim 13, wherein said first and second biasing members further comprise an engagement member disposed on each of said first and second biasing member.

15. The extendable spring post extension member of claim 13, wherein said retention notch comprises one of a “J” shape, an “L” shape, or a “V” shape.

16. The extendable spring post extension member of claim 13, wherein said extension retention notch comprises one of a “J” shape, an “L” shape, or a “V” shape.
